(19) United States
(12) Patent Application Publication
(10) Pub. No.: US 2015/0032317 A1
(43) Pub. Date: Jan. 29, 2015

(54) CONTROL DEVICE OF HYBRID VEHICLE

(71) Applicant: Mitsuharu Kato, Nagoya-shi (JP)

(72) Inventor: Mitsuharu Kato, Nagoya-shi (JP)

(73) Assignee: TOYOTA JIDOSHA KABUSHIKI KAISHA, Toyota-shi (JP)

(21) Appl. No.: 14/379,097

(22) PCT Filed: Feb. 15, 2012
(86) PCT No.: PCT/JP2012/053559

§ 371 Date: Aug. 15, 2014

(51) Int. Cl. B60W 10/26; B60W 20/00; B60K 6/445; B60W 10/08

(52) U.S. Cl. CPC B60W 10/26; B60W 10/08; B60W 20/00; B60K 6/445; Y10S 903/93
USPC 701/22; 180/65.265; 903/930

(57) ABSTRACT

An ECU serving as a control device of a hybrid vehicle including an engine; a first motor generator and a second motor generator capable of generating power and generating regenerative power; and a battery configured to supply and receive power to and from the first motor generator and the second motor generator includes a plurality prediction arithmetic expressions configured to predict a regenerative power generation amount generated by the first motor generator (or the second motor generator) at the time an own vehicle travels on a downhill road in a travel scheduled path of the own vehicle, wherein one of the plurality of prediction arithmetic expressions is selected and used for the predicting the regenerative power generation amount according to a gradient of the downhill road.

### FIELD

The present invention relates to a control device of a hybrid vehicle.

### BACKGROUND

A hybrid vehicle that travels with an engine and a motor generator as power sources is recently known. In such hybrid vehicle, the motor generator is driven by an electric power of a battery to generate power, and uses the rotation of drive wheels and the power of the engine to carry out regenerative power generation at the time of vehicle deceleration to charge the battery.

During the travelling of the vehicle, a charged state (State Of Charge: SOC) of the battery is preferably within a predetermined range, and it is desirable to accurately estimate the changing amount in increase and decrease of the SOC of when travelling on a travel scheduled path ahead to suitably maintain such charged state. The regenerative power generation amount by the motor generator differs depending on an uphill road, a downhill road, a flat road, and the like even at the same vehicle speed, and the changing amount of the SOC differs depending on a gradient of the travelling road. Thus, a technique of predicting the regenerative power generation amount at the time of travelling on the downhill road based on gradient information of the travel scheduled path is conventionally disclosed (e.g., Patent Literatures 1 to 3).

### CITATION LIST

### Patent Literature

Patent Literature 1: Japanese Patent Application Laid-open No. 2009-274611

Patent Literature 2: Japanese Patent Application Laid-open No. 2009-090735

Patent Literature 3: Japanese Patent Application Laid-open No. 2008-024306

### SUMMARY

### Technical Problem

However, the conventional techniques disclosed in Patent Literatures 1 to 3 can be further improved to predict the regenerative power generation amount at the time of travelling on the downhill road with high accuracy.

In light of the foregoing, it is an object of the present invention to provide a control device of a hybrid vehicle capable of accurately predicting the regenerative power generation amount at the time of travelling on the downhill road.

### Solution to Problem

In order to achieve the above mentioned object, a control device according to the present invention of a hybrid vehicle including an engine, at least one motor generator capable of generating power and generating regenerative power, and a power accumulating device configured to supply and receive power to and from the motor generator, the control device includes a plurality of power generation amount predicting means configured to predict a regenerative power generation amount generated by the motor generator at the time an own vehicle travels on a downhill road in a travel scheduled path of the own vehicle, wherein one of the plurality of power generation amount predicting means is selected and used for predicting the regenerative power generation amount according to a gradient of the downhill road.

Further, it is preferable that in a region where the gradient of the downhill road is higher than a first threshold value, a power generation amount predicting means configured to predict the regenerative power generation amount based only on an elevation difference of the downhill road is selected among the plurality of power generation amount predicting means.

Further, it is preferable that in a region where the gradient of the downhill road is lower than a first threshold value, a power generation amount predicting means configured to predict the regenerative power generation amount based on an elevation difference and the gradient of the downhill road is selected among the plurality of power generation amount predicting means.

Further, it is preferable that in a region where the gradient of the downhill road is lower than a second threshold value, which is on a low gradient side than the first threshold value, a power generation amount predicting means configured to predict the regenerative power generation amount similar to the time of travelling on a flat road is selected.

### Advantageous Effects of Invention

The control device of the hybrid vehicle according to the present invention selects one of the plurality of power generation amount predicting means according to the gradient of the downhill road and uses the same for the prediction of the regenerative power generation amount, so that the regenerative power generation amount can be predicted with a suitable method in accordance with the gradient of the downhill road, and consequently, the regenerative power generation amount at the time of downhill road travelling can be accurately predicted.

### BRIEF DESCRIPTION OF DRAWINGS

FIG. 1 is a view illustrating a schematic configuration of a control device of a hybrid vehicle according to one embodiment of the present invention.

FIG. 2 is a view illustrating a relationship of an average gradient and a ΔSOC increase amount at the time of downhill road travelling.

FIG. 3 is a flowchart illustrating a prediction process of the ΔSOC increase amount at the time of downhill road travelling performed in the present embodiment.

### DESCRIPTION OF EMBODIMENTS

An embodiment of a control device of a hybrid vehicle according to the present invention will be hereinafter described based on the drawings. In the following drawings, the same reference numerals are denoted on the same or corresponding portions, and the description thereof will not be repeated.

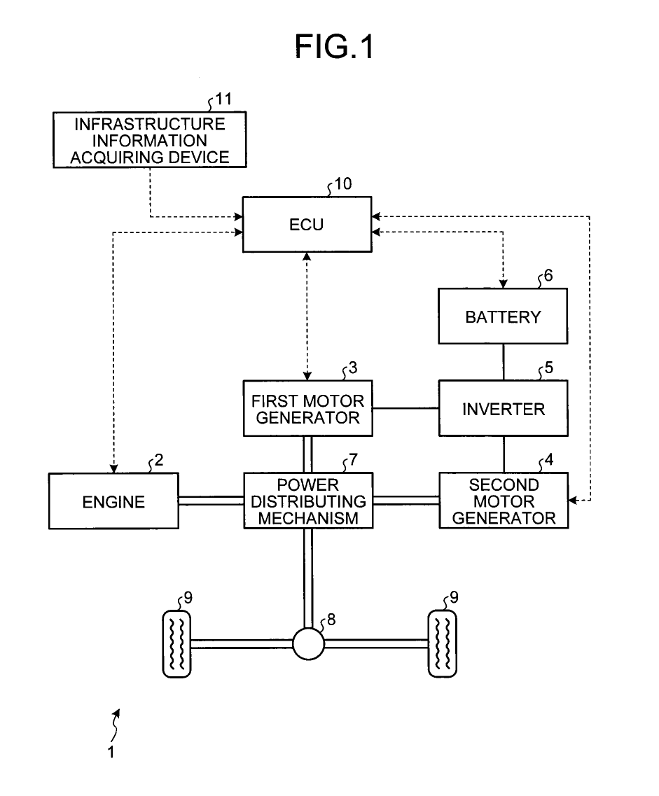

First, a configuration of the control device of the hybrid vehicle according to one embodiment of the present invention will be described with reference to FIG. 1. FIG. 1 is a view illustrating a schematic configuration of the control device of the hybrid vehicle according to one embodiment of the present invention.

As illustrated in FIG. 1, a hybrid vehicle 1 includes an engine 2, a first motor generator 3, which is an electric motor that can generate power, and a second motor generator 4 as motors to rotatably drive and forward drive wheels 9.

The engine 2 is an internal combustion engine that outputs power by combusting hydrocarbon-based fuel such as gasoline, diesel oil, or the like, and is well known to include an intake device, an exhaust device, a fuel injection device, an ignition device, a cooling device, and the like. The engine 2 is performed with driving control such as fuel injection control, ignition control, intake air amount adjustment control, and the like by an ECU 10 to which signals from various types of sensors that detect the driving state of the engine 2 are input.

The first motor generator 3 and the second motor generator 4 are a well-known alternating-current synchronized power generating electric motors having a function (power running function) of an electric motor that outputs a motor torque by the supplied electric power, and a function (regenerating function) of a power generator that converts an input mechanical power to an electric power. The first motor generator 3 is mainly used as the power generator, and the second motor generator 4 is mainly used as the electric motor. The first motor generator 3 and the second motor generator 4 supply and receive power to and from a battery 6 (power accumulating device) via an inverter 5. The power running control as the electric motor or the regenerating control as the power generator of the first motor generator 3 and the second motor generator 4 are controlled by the ECU 10.

The inverter 5 is configured so that the electric power generated by one of the first motor generator 3 or the second motor generator 4 can be consumed by the other motor generator. The inverter 5 basically converts the electric power accumulated in the battery 6 from direct-current to alternating-current and supplies the power to the second motor generator 4, and also converts the electric power generated by the first motor generator 3 from alternating-current to direct-current and accumulates the power in the battery 6. Therefore, the battery 6 is charged and discharged by the electric power generated by either one of the first motor generator 3 or the second motor generator 4, and the lacking electric power. If the electric power balance is realized by the first motor generator 3 and the second motor generator 4, the battery 6 is not charged nor discharged. The electric power supply and the electric power collection of the inverter 5 are controlled by the ECU 10.

The engine 2, the first motor generator 3, the second motor generator 4, and the drive wheels 9 are coupled by a power distributing mechanism 7. The power distributing mechanism 7 divides the engine torque output from the engine 2 to the first motor generator 3 and the drive wheel 9, and transmits the motor torque output from the second motor generator 4 to the drive wheels 9. The power distributing mechanism 7 is configured to include, for example, a planetary gear unit.

The engine torque output from the engine 2 or the motor torque output from the second motor generator 4 are transmitted to a pair of drive wheels 9 via the power distributing mechanism 7 and a differential gear 8. The first motor generator 3 regeneratingly generates the electric power by the engine torque divided and supplied by the power distributing mechanism 7.

In the present embodiment, there is illustrated the configuration in which two motor generators, the first motor generator 3 and the second motor generator 4, are arranged, one functioning as the power generator and the other functioning as the electric motor, but a configuration in which a single motor generator functions as one of the electric motor or the power generator may be adopted.

The hybrid vehicle 1 includes the ECU (Electronic Control Unit) 10 as a control device configured to control the operation of the engine 2, the first motor generator 3, the second motor generator 4, the inverter 5, the power distributing mechanism 7, and the like and control the travelling of the vehicle. The ECU 10 is configured so that information associated with the charged state (State Of Charge: SOC) of the battery 6 can be acquired from the battery 6, and the SOC can be monitored.

The hybrid vehicle 1 includes an infrastructure information acquiring device 11. The infrastructure information acquiring device 11 acquires infrastructure information at the periphery of the vehicle 1 that can be acquired by cooperating with the infrastructure. The infrastructure information acquiring device 11, for example, is configured by various devices such as a device for transmitting and receiving various types of information from a transmitter/receiver such as an optical beacon installed on the road side, and the like to a road-vehicle communication device of the vehicle 1, a GPS device, a navigation device, an inter-vehicle communication device, a device for receiving information from a VICS (registered trademark) (Vehicle Information and Communication System) center, and the like. The infrastructure information acquiring device 11 acquires, for the infrastructure information, road information of the road on which the vehicle 1 travels, traffic light information related to the traffic light ahead in the travelling direction of the vehicle 1, and the like, for example. The road information typically includes gradient information of the road on which the vehicle 1 travels, the speed limit information, stop line position information of the intersection, and the like. The traffic light information typically includes traffic light cycle information such as a lighting cycle, traffic light change timing of the green light, yellow light, and red light of the traffic light, and the like. The infrastructure information acquiring device 11 is connected to the ECU 10, and transmits the acquired infrastructure information to the ECU 10.

The ECU 10 is configured to be able to predict the changing amount in increase and decrease of the SOC (hereinafter described as “ΔSOC”). The ECU 10, for example, can predict the regenerative power generation amount by the power generator (e.g., first motor generator 3) and the electric power consumption amount by the electric motor (e.g., second motor generator 4) of when travelling on the travelling road ahead based on the infrastructure information acquired by the infrastructure information acquiring device 11, and calculate the ΔSOC based on a difference between the predicted regenerative power generation amount and the electric power consumption amount.

When the vehicle 1 travels on the downhill road, a situation in which the regenerative power generation amount of the power generator increases compared to when travelling on the flat road upon being influenced by the potential energy by the elevation difference is considered. Thus, when predicting the regenerative power generation amount in travelling the downhill road in the travel scheduled path of the own vehicle, the increase amount (hereinafter also referred to as “ΔSOC increase amount” or “downhill ΔSOC”) of the regenerative power generation amount originating from the downhill road travelling needs to be taken into consideration in addition to the regenerative power generation amount that can be predicted at the time of the flat road travelling. The ECU 10 of the present embodiment is thus configured to be able to predict the ΔSOC increase amount of when there is a downhill road in the path ahead.

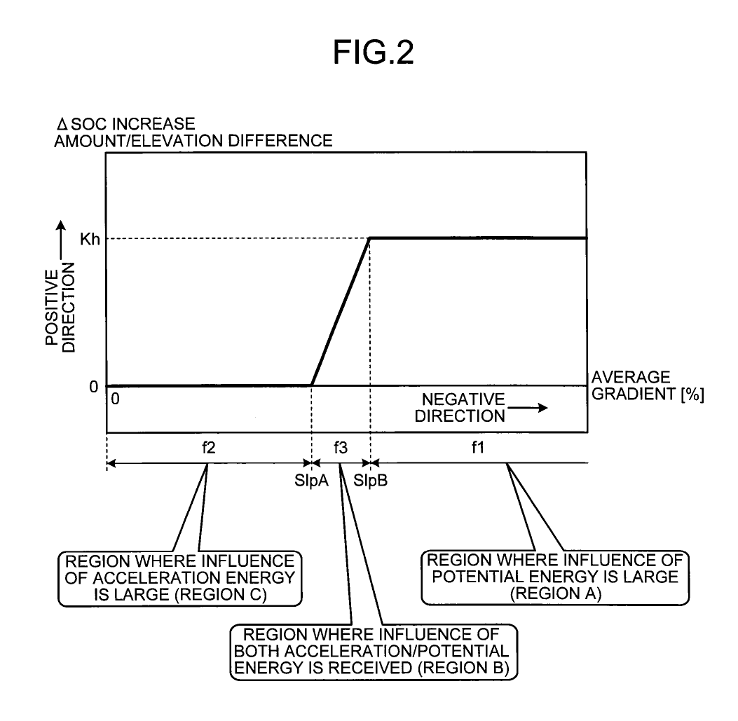

The prediction method of the ΔSOC increase amount by the downhill road travelling will be described in detail with reference to FIG. 2. FIG. 2 is a view illustrating a relationship of an average gradient and the ΔSOC increase amount at the time of downhill road travelling. The horizontal axis of FIG. 2 indicates the average gradient [%] of the downhill road. The average gradient is 0 at the left end of the horizontal axis, and increases in the negative direction, that is, the downhill gradient becomes larger toward the right direction of the horizontal axis. The vertical axis of FIG. 2 indicates the ΔSOC increase amount (ΔSOC increase amount/elevation difference) per unit elevation difference, and increases in the positive direction toward the upward direction.

When generally referring to the downhill road, the energy received by the vehicle body changes in various ways according to the downhill gradient, and thus the ΔSOC increase amount also differs. For example, in the case of high gradient (downhill gradient is steep), the influence of the potential energy by the elevation difference is greatly received and hence the ΔSOC increase amount increases proportional to the elevation difference. In the case of low gradient (downhill gradient is gradual), the elevation difference is small and the influence of the potential energy is small, and furthermore, an acceleration energy is required for travelling according to the extent of the gradient, and hence the ΔSOC increase amount may not be proportional to the elevation difference.

Thus, in the present embodiment, the downhill road is classified into three regions according to the gradient of the downhill zone, a region A where the influence of the potential energy is large, a region B where the influence of both the acceleration energy and the potential energy is received, and a region C where the influence of the acceleration energy is large, as illustrated in FIG. 2. More specifically, two threshold values satisfying the magnitude relationship of SlpA>SlpB are set with respect to the gradient, where the region smaller than SlpB (first threshold value) (large gradient) is sectionalized as region A, the region greater than SlpA (second threshold value) (small gradient) is sectionalized as region C, and the region greater than or equal to SlpB and smaller than or equal to SlpA is sectionalized as region B.

The ECU 10 includes a plurality of prediction arithmetic expressions f1, f2, f3 (power generation amount predicting means) for predicting the ΔSOC increase amount, and is configured to select one of the plurality of prediction arithmetic expressions f1, f2, f3 to use for the prediction of the ΔSOC increase amount, the prediction arithmetic expression being different for each of the three regions A, B, C classified according to the gradient.

In the region A, the downhill gradient is large and the influence of the potential energy is large, and hence the ΔSOC increase amount is proportional to the elevation difference and the increase amount per unit elevation difference can be assumed as a constant Kh, as illustrated in FIG. 2. Therefore, the prediction arithmetic expression f1 selected in the region A can be expressed with the following equation (1).

f1 (distance, gradient)=Kh×elevation difference (1)

The “elevation difference” on the right side of equation (1) can be calculated from the distance and the gradient. The prediction arithmetic expression f1 can predict the regenerative power generation amount based only on the elevation difference of the downhill road.

In the region C, the downhill gradient is small, the influence of the potential energy is small, and the influence of the acceleration energy is large similar to the flat road, and hence the influence by the downhill road can be ignored. Thus, in the region C, the increase amount per unit elevation difference can be assumed as zero, as illustrated in FIG. 2. Therefore, the prediction arithmetic expression f2 selected in the region C can be expressed with the following equation (2).

F2( )=0 (2)

That is, the prediction arithmetic expression f2 predicts the regenerative power generation amount similar to the time of the flat road travelling, and thus in the region C, the ΔSOC increase amount becomes zero regardless of the gradient and the regenerative power generation amount is predicted similar to the time of the flat road travelling.

In the region B, the region is positioned between the region A and the region C and is subjected to the influence of both the acceleration energy and the potential energy, and thus the increase amount per unit elevation difference continuously transitions from zero to Kh according to the gradient, as illustrated in FIG. 2. Therefore, the prediction arithmetic expression f3 selected in the region B is expressed with the following equation (3).

F3 (distance, gradient)=Kh/(SlpB−SlpA)×(average gradient−SlpA)×elevation difference (3)

That is, the prediction arithmetic expression f3 can predict the regenerative power generation amount based on the elevation difference and the gradient of the downhill road.

The parameters Kh, SlpA, SlpB used in the equations (1) to (3) are vehicle adaptive values (constants) obtained from test data.

The ECU 10 can predict and calculate the regenerative power generation amount of the downhill road by adding the ΔSOC increase amount (downhill ΔSOC) calculated by the prediction arithmetic expressions f1, f2, f3 to the change amount of the regenerative power generation amount of the flat road.

The ECU 10 is physically an electronic circuit having a well-known microcomputer including a CPU (Central Processing Unit), RAM (Random Access Memory), ROM (Read Only Memory), and an interface as the main body. The function of the ECU 10 described above is realized by loading the application program held in the ROM to the RAM and executing the program with the CPU to operate various types of devices in the vehicle 1 under the control of the CPU and carry out readout and write of the data in the RAM and the ROM. The ECU 10 is not limited to the function described above, and has various other functions to use as the ECU of the vehicle 1. The ECU may have a configuration including a plurality of ECUs such as an engine ECU for controlling the engine 2, a motor ECU for controlling the first motor generator 3 and the second motor generator 4, a battery ECU for monitoring the battery 6, and the like.

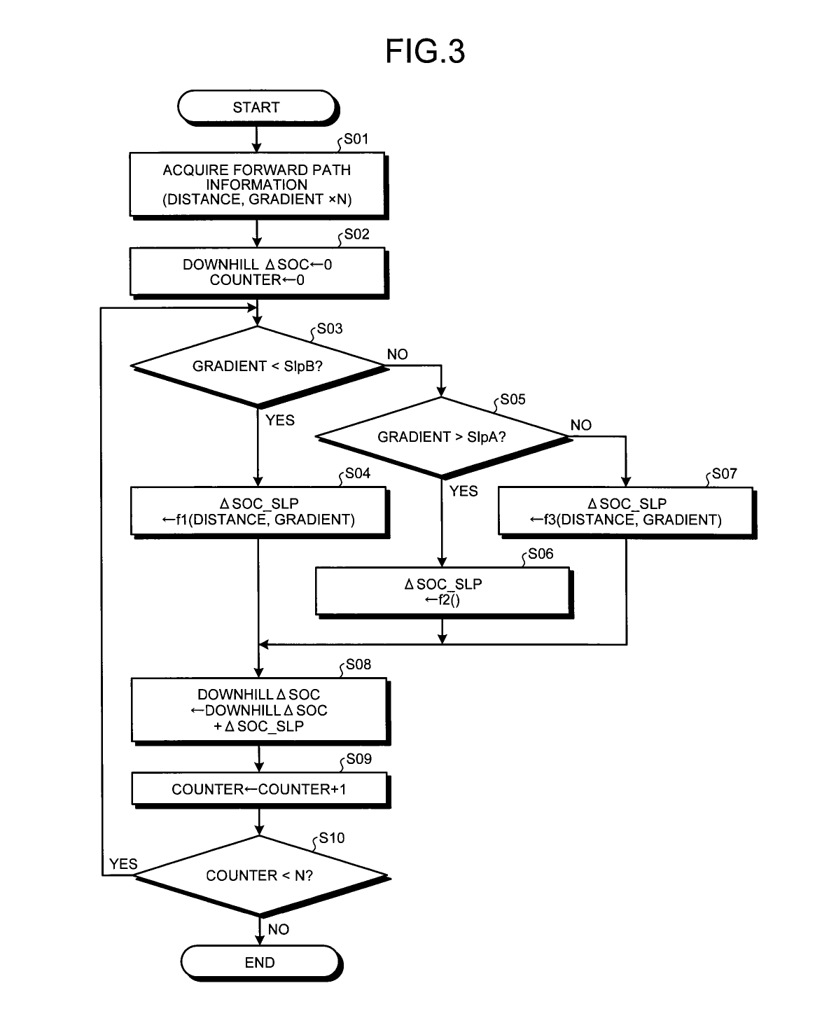

The operation of the control device of the hybrid vehicle according to the present embodiment will now be described with reference to FIG. 3. FIG. 3 is a flowchart illustrating the prediction process of the ΔSOC increase amount at the time of the downhill road travelling performed in the present embodiment.

A series of processes illustrated in the flowchart of FIG. 3 are performed in a situation where the vehicle 1 is proximate to the downhill road or in a situation where the vehicle 1 is passing the downhill road by the ECU 10.

First, the forward path information is acquired (S01). The forward path information specifically includes distance information and gradient information of each zone for predetermined N zones of the travel scheduled path ahead of the vehicle. The distance information is information associated with the distance of the road in the relevant zone, and the gradient information is the information associated with the gradient of the road in the relevant zone, and more specifically, the average gradient of the relevant zone. The forward path information can be acquired, for example, by extracting from the infrastructure information acquired by the infrastructure information acquiring device 11.

The downhill ΔSOC indicating the total ΔSOC increase amount for the N zones and the counter are then set to zero (S02), and the calculation process of the downhill ΔSOC is started.

First, the calculation process of ΔSOC_SLP indicating the ΔSOC increase amount of each zone is carried out based on the forward path information of the first zone. Whether or not the average gradient of the relevant zone is smaller than the first threshold value SlpB is checked using the gradient information of the forward path information (S03).

If determined that the average gradient of the relevant zone is smaller than the first threshold value SlpB in S03 (Yes in S03), the region is the region A in which the downhill gradient of the relevant zone is large and the influence of the potential energy is large, that is, the region A illustrated in FIG. 2, and thus the prediction arithmetic expression f1 is selected. The ΔSOC_SLP of the relevant zone is calculated by substituting the distance and the average gradient of the zone to the prediction arithmetic expression f1 shown in equation (1) (S04), and the process proceeds to step S08.

If determined that the average gradient of the relevant zone is greater than or equal to the first threshold value SlpB in step S03 (No in S03), whether or not the average gradient of the zone is greater than the second threshold value SlpA is then checked (S05).

If determined that the average gradient of the relevant zone is greater than the second threshold value SlpA in S05 (Yes in S05), the region is the region in which the downhill gradient of the relevant zone is small and the influence of the acceleration energy is large, that is, the region C illustrated in FIG. 2, and thus the prediction arithmetic expression f2 is selected and the ΔSOC_SLP of the relevant zone is calculated (S06), and the process proceeds to step S08. Specifically, ΔSOC_SLP becomes zero regardless of the gradient of the zone in step S06.

If determined that the average gradient of the relevant zone is smaller than or equal to the second threshold value SlpA in S05 (No in S05), the region is the region in which the downhill gradient of the relevant zone is between SlpA and SlpB and the influence of both the acceleration energy and the potential energy is received, that is, the region B illustrated in FIG. 2, and thus the prediction arithmetic expression f3 is selected. The increase amount ΔSOC_SLP of the relevant zone is calculated (S07) by substituting the distance and the average gradient of the zone to the prediction arithmetic expression f3 shown in equation (3), and the process proceeds to step S08.

The increase amounts ΔSOC_SLP of the zone calculated in steps S04, S06, S07 are added to the downhill ΔSOC (S08), and the counter is incremented by one (S09).

Whether or not the counter is smaller than N is then checked (S10). If the counter is smaller than N, the process returns to step S03, and the calculation of the increase amount of the next zone and the update of the downhill ΔSOC are repeated for N times, a predetermined number of loops. If the counter is greater than or equal to N, the process is terminated after handling such as storing the downhill ΔSOC, which is an integrated value of the increase amounts for N zones, in the ECU 10, and the like assuming the predetermined number of loops is finished.

The effects of the control device of the hybrid vehicle according to the present embodiment will now be described.

The ECU 10 is a control device of the hybrid vehicle 1 including the engine 2, the first motor generator 3 and the second motor generator 4, which can generate power and can generate regenerative power, and the battery 6 for supplying and receiving electric power to and from the first motor generator 3 and the second motor generator 4. The ECU 10 serving as the control device of the hybrid vehicle 1 includes a plurality of prediction arithmetic expressions f1, f2, f3 for predicting the regenerative power generation amount generated by the first motor generator 3 (or second motor generator 4) when travelling on the downhill road in the travel scheduled path of the own vehicle, and selects one of the plurality of prediction arithmetic expressions f1, f2, f3 to use for the prediction of the regenerative power generation amount according to the gradient of the downhill road.

The regenerative power generation amount on the downhill road is correlated with the elevation difference (potential energy) and the acceleration energy of the downhill road, but the respective correlativity differs according to the gradient of the downhill road. In the present embodiment, according to the configuration described above, one of the plurality of prediction arithmetic expressions is selected according to the gradient of the downhill road and used for the prediction of the regenerative power generation amount, so that the regenerative power generation amount can be predicted with a suitable method in accordance with the gradient of the downhill road, and the regenerative power generation amount at the time of the downhill road travelling can be accurately predicted.

Further, in the ECU 10 serving as the control device of the hybrid vehicle 1, the prediction arithmetic expression f1 that predicts the regenerative power generation amount based solely on the elevation difference of the downhill road is selected from the plurality of prediction arithmetic expressions f1, f2, f3 in the region A where the gradient of the downhill road is higher than the first threshold value SlpB.

According to such configuration, in the region A where the downhill gradient is large and the influence of the potential energy is large, the regenerative power generation amount can be predicted based on the elevation difference of the downhill road using the prediction arithmetic expression f1 shown as equation (1), and hence the regenerative power generation amount at the time of the downhill road travelling can be more accurately predicted.

In the ECU 10 serving as the control device of the hybrid vehicle 1, the prediction arithmetic expression f3 that predicts the regenerative power generation amount based on the elevation difference and the gradient of the downhill road is selected from the plurality of prediction arithmetic expressions f1, f2, f3 in the region B where the gradient of the downhill road is lower than the first threshold value SlpB.

According to such configuration, in the region B where the downhill gradient is small compared to the region A and the influence of both the acceleration energy and the potential energy is received, the regenerative power generation amount can be predicted based on the elevation difference and the gradient of the downhill road using the prediction arithmetic expression f3 shown in equation (3), and hence the regenerative power generation amount at the time of the downhill road travelling can be more accurately predicted.

In the ECU 10 serving as the control device of the hybrid vehicle 1, the prediction arithmetic expression f2 that predicts the regenerative power generation amount similar to the time of the flat road travelling is selected in the region C where the gradient of the downhill road is lower than the second threshold value SlpA on the low gradient side than the first threshold value SlpB.

According to such configuration, in the region C where the gradient is smaller than the regions A, B, the influence of the potential energy is small, and the influence of the acceleration energy is large similar to the flat road, the regenerative power generation amount can be predicted similar to the time of the flat road travelling while ignoring the influence by the downhill road using the prediction arithmetic expression f2 shown in equation (2), and hence the regenerative power generation amount at the time of the downhill road travelling can be more accurately predicted.

The suitable embodiments have been described for the present invention, but the present invention should not be limited by such embodiments. The present invention can have each configuring element of the embodiment changed to an element easily replaceable by those skilled in the art or the substantially the same element.

### REFERENCE SIGNS LIST

1 HYBRID VEHICLE
2 ENGINE
3 FIRST MOTOR GENERATOR
4 SECOND MOTOR GENERATOR
6 BATTERY (POWER ACCUMULATING DEVICE)
10 ECU (CONTROL DEVICE)
f1, f2, f3 PREDICTION ARITHMETIC EXPRESSION (POWER GENERATION AMOUNT PREDICTING MEANS)
SlpB FIRST THRESHOLD VALUE
SlpA SECOND THRESHOLD VALUE

1-4. (canceled)

5. A control device of a hybrid vehicle including an engine, at least one motor generator capable of generating power and generating regenerative power, and a power accumulating device configured to supply and receive power to and from the motor generator, the control device comprising:
a plurality of power generation amount predicting unit configured to predict a regenerative power generation amount generated by the motor generator at the time an own vehicle travels on a downhill road in a travel scheduled path of the own vehicle, wherein
the plurality of power generation amount predicting unit are configured with different correlativity of a potential energy and an acceleration energy so that an influence of the potential energy becomes greater the higher a gradient and an influence of the acceleration energy becomes greater the lower the gradient, and
one of the plurality of power generation amount predicting unit to use for predicting the regenerative power generation amount is selected according to a gradient of the downhill road among the plurality of power generation amount predicting unit.

6. The control device of the hybrid vehicle according to claim 5, wherein
in a region where the gradient of the downhill road is higher than a first threshold value, a power generation amount predicting unit configured to predict the regenerative power generation amount based only on an elevation difference of the downhill road is selected among the plurality of power generation amount predicting unit.

7. The control device of the hybrid vehicle according to claim 5, wherein
in a region where the gradient of the downhill road is lower than a first threshold value, a power generation amount predicting unit configured to predict the regenerative power generation amount based on an elevation difference and the gradient of the downhill road is selected among the plurality of power generation amount predicting unit.

8. The control device of the hybrid vehicle according to claim 6, wherein
in a region where the gradient of the downhill road is lower than a second threshold value, which is on a low gradient side than the first threshold value, a power generation amount predicting unit configured to predict the regenerative power generation amount similar to the time of travelling on a flat road is selected.

9. The control device of the hybrid vehicle according to claim 6, wherein
in a region where the gradient of the downhill road is lower than a first threshold value, a power generation amount predicting unit configured to predict the regenerative power generation amount based on an elevation difference and the gradient of the downhill road is selected among the plurality of power generation amount predicting unit.

10. The control device of the hybrid vehicle according to claim 7, wherein
in a region where the gradient of the downhill road is lower than a second threshold value, which is on a low gradient side than the first threshold value, a power generation amount predicting unit configured to predict the regenerative power generation amount similar to the time of travelling on a flat road is selected.
